(19) United States
(12) Patent Application Publication
(10) Pub. No.: US 2011/0254830 A1
(43) Pub. Date: Oct. 20, 2011

(54) SCAN SIGNAL TRANSMISSION SYSTEM AND METHOD THEREOF

(76) Inventors: Chia-Hsien CHANG, Hsinchu County (TW); Shu-Yang Lin, Yunlin County (TW)

(21) Appl. No.: 12/836,259

(22) Filed: Jul. 14, 2010

(30) Foreign Application Priority Data
Apr. 20, 2010 (TW) 099112347

(51) Int. Cl. G09G 5/00

(52) U.S. Cl. 345/213; 345/211

(57) ABSTRACT

A scan signal transmission system and a method thereof are provided, which are applicable to a display device. The system includes a display area circuit and a gate circuit, the display area circuit has a plurality of pixel scan lines, and the gate circuit is connected to each of the pixel scan lines. The gate circuit is used for obtaining a scan signal from a clock generator, so as to transmit the scan signal to each of the pixel scan lines sequentially. During each frame scan operation, the gate circuit transmits the scan signal to the pixel scan lines in a reverse signal transmission direction.

### CROSS-REFERENCE TO RELATED APPLICATION

This application claims the benefit of Taiwan Patent Application No. 099112347, filed on Apr. 20, 2010, which is hereby incorporated by reference for all purposes as if fully set forth herein.

### BACKGROUND OF THE INVENTION

1. Field of Invention

The present invention relates to a scan signal transmission system of a liquid crystal display (LCD) device, and more particularly to a scan signal transmission system and a method thereof, which are applicable to transmit a scan signal to each pixel scan line in reverse signal transmission directions during two continuous frame scan operations.

2. Related Art

Referring to FIGS. 1A, 1B, 1C, and 1D together, FIG. 1A is a schematic view of a configuration and a parasitic capacitance of a pixel circuit in the prior art, FIG. 1B is a schematic view of an ideal voltage of the pixel circuit in the prior art, FIG. 1C is a schematic view of a practical voltage of the pixel circuit in the prior art, and FIG. 1D is a schematic view of scan signal variation in the prior art. In the prior art, while driving an LCD device, a “polarity reversal” technology has to be adopted in a display circuit of the LCD device, so as to eliminate the direct current (DC) residue of liquid crystals. In an ideal state, each pixel circuit 1 obtains a scan signal V_{g} (that is, the scan signal V_{g} provided by a gate circuit 4 as shown in FIG. 1D), and obtains a drain voltage V_{d} by using a positive-polarity structure (V_{d}>V_{com}) and a negative-polarity structure (V_{d}<V_{com}) alternatively.

In fact, as shown in FIGS. 1A and 1C, the pixel circuit 1 generates a parasitic capacitance C_{gd} during operation, and the drain voltage V_{d} is affected by a capacitance coupling effect of the parasitic capacitance C_{gd}. That is to say, when the scan signal V_{g} is turned from ON to OFF, the pixel circuit 1 generates a pixel voltage difference ΔVₚ, and the pixel voltage different ΔVₚ offsets the drain voltage V_{d}, such that the symmetry of the drain voltage V_{d} about a common drain voltage axis value V_{com} is poorer than that shown in FIG. 1B. The symmetry of the drain voltage V_{d} about the common drain voltage axis value V_{com} may be restored by adjusting the level of V_{com}. However, as the scan signal passes more and more pixel circuits 1, the scan signal V_{g} is gradually deformed along with the change of the circuit resistance, as shown in FIG. 1D. In addition, the ΔVₚ is electrically coupled by different pixel circuits 1 to different extents, and the LCD device flickers since the liquid crystals have non-uniform voltages, so that manufacturers usually configure a chamfered integrated circuit (IC) to eliminate the flickering phenomenon.

However, the above solution of eliminating the flickering phenomenon cannot solve the flickering problem in an LCD device having a large area. In the LCD device having a large area, the number of pixel circuits dramatically increases as the display area is enlarged, and the scan signal V_{g} may be totally deformed as the number of passed pixel circuits increases, such that the chamfered IC cannot work well to eliminate the flickering phenomenon any more.

Therefore, how to provide a solution suitable for LCD devices of any size and eliminating the flickering phenomenon of the LCD devices has become a problem for being solved by the manufacturers.

### SUMMARY OF THE INVENTION

The present invention is directed to a scan signal transmission system and a method thereof, which are applicable to transmit a scan signal to the pixel scan line in reverse directions during two continuous frame scan operations.

In order to solve the above-mentioned system problem, the present invention provides a scan signal transmission system applied in a display device. The scan signal transmission system includes a display area circuit and a gate circuit. The display area circuit includes a plurality of pixel scan lines which is electrically connected to the gate circuit. The gate circuit transmits at least one scan signal to the pixel scan lines sequentially according to an arrangement sequence of the pixel scan lines for executing scan operations, and the gate circuit transmits the scan signal to the pixel scan line in a reverse signal transmission direction during a next frame scan operation.

The scan signal transmission system of the present invention further includes a clock generator for periodically generating the scan signal and transmitting the scan signal to the gate circuit.

In order to solve the above-mentioned system problem, the present invention provides a scan signal transmission method, applied in a display device having a plurality of pixel scan lines. The scan signal transmission method includes the steps of: a gate circuit is provided to be electrically connected to the pixel scan lines and the gate circuit transmits at least one scan signal to the pixel scan lines sequentially according to an arrangement sequence of the pixel scan lines, wherein during frame scan operations, the gate circuit transmits the scan signal to the pixel scan lines in reverse signal transmission directions of two continuous frame. That is, in a scan operation, the directions of the scan signal transmitted by the gate circuit in two continuous frames are reversed.

In the scan signal transmission method of the present invention, the gate circuit obtains the scan signal periodically from a clock generator.

The present invention is characterized in that, in the scan operation of two continuous frames, the transmission directions of the scan signal in the pixel scan lines are reversed, and thus the electric coupling effects of each pixel circuit in two frame scan operations are presented in opposite modes, such that the brightness and colorfulness of the display frame of the display device achieve a constant visual effect, thereby reducing the flickering effect generated by the display device, which can be applied to display devices of various sizes. Moreover, it is unnecessary for the manufactures to dispose the chamfered IC on the display device, thus reducing the design and production costs of the display device.

### BRIEF DESCRIPTION OF THE DRAWINGS

FIG. 1A is a schematic view of a configuration and a parasitic capacitance of a pixel circuit in the prior art;

FIG. 1B is a schematic view of an ideal voltage of the pixel circuit in the prior art;

FIG. 1C is a schematic view of a practical voltage of the pixel circuit in the prior art;

FIG. 1D is a schematic view of scan signal variation in the prior art;

FIG. 2 is a schematic view of system architecture of a scan signal transmission system according to an embodiment of the present invention;

FIG. 3 shows an embodiment of the system architecture of FIG. 2 according to the present invention;

FIG. 4 is a schematic view of signal analysis about electric coupling among a pixel circuit a, a pixel circuit b, and a pixel circuit c in a scan signal transmission system according to an embodiment of the present invention;

FIGS. 5A and 5B are schematic views of another system architecture of a scan signal transmission system according to an embodiment of the present invention; and

FIG. 6 is a schematic view of a scan signal transmission method according to an embodiment of the present invention.

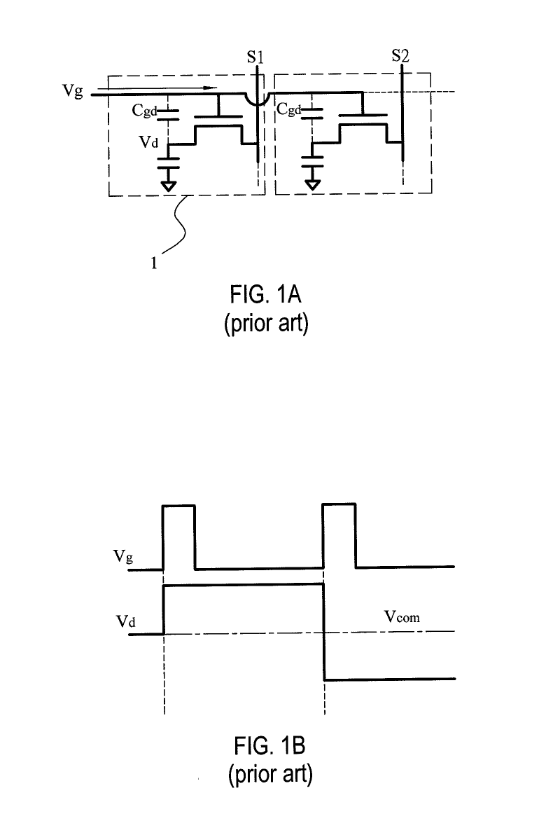

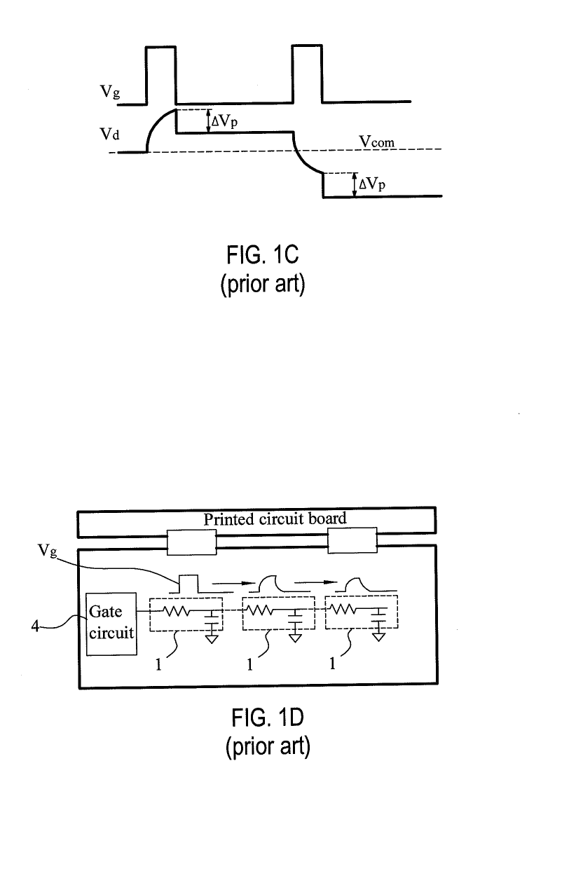

### DETAILED DESCRIPTION OF THE INVENTION

Preferred embodiments of the present invention are illustrated in detail below with reference to the accompanying drawings.

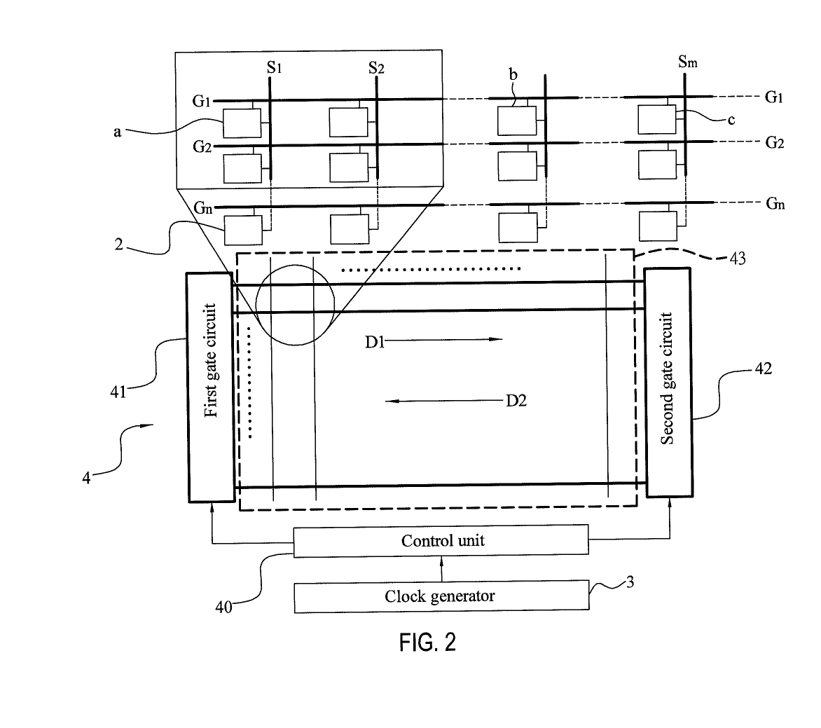

FIG. 2 is a schematic view of system architecture of a scan signal transmission system according to an embodiment of the present invention. Referring to FIG. 2, the system provided in this embodiment is applicable to a display device (not shown), and the display device includes a display area circuit 43. The display area circuit 43 includes a plurality of pixel circuits 2, a plurality of pixel scan lines (G₁˜Gₙ) is connected to the pixel circuits 2, each of the pixel scan lines (G₁˜Gₙ) is individually connected to the pixel circuits 2 in one row, each of the pixel scan lines (G₁˜Gₙ) is connected to a gate circuit 4, and the gate circuit 4 is further electrically connected to a clock generator 3.

The clock generator 3 is used for periodically generating at least one scan signal, and transmitting the scan signal to the gate circuit 4. The gate circuit 4 receives the scan signal generated by the clock generator 3, and transmits the scan signal to each of the pixel scan lines (G₁˜Gₙ) sequentially according to an arrangement sequence of the pixel scan lines (G₁˜Gₙ).

A plurality of pixel data lines (S₁˜Sₘ) is connected to the pixel circuits 2, and each of the pixel data lines (S₁˜Sₘ) is individually connected to the pixel circuit 2 in one column. It should be noted that, terminals of the pixel data lines (S₁˜Sₘ) are connected to a source circuit (not shown), and the source circuit provides frame data and updates setting data of each of the pixel circuits 2 through the pixel data lines (S₁˜Sₘ) together with the gate circuit 4. However, the data setting of the pixel circuits 2 and the polarity reversal of the pixel circuits 2 are well known to those of ordinary skill in the art of the LCD device, which are not repeated here.

In this embodiment, a specification of the gate circuit 4 is, for example, a dual gate drive circuit. The gate circuit 4 includes a control unit 40, a first gate circuit 41, and a second gate circuit 42. The first gate circuit 41 and the second gate circuit 42 are connected to two ends of each of the pixel scan lines (G₁˜Gₙ). The control unit 40 receives a scan signal V_{g} generated by the clock generator 3, and controls the first gate circuit 41 and the second gate circuit 42 to transmit the scan signal to each of the pixel scan lines (G₁˜Gₙ) sequentially according to an arrangement sequence of the pixel scan lines (G₁˜Gₙ). In the following, the transmission direction of the scan signal is illustrated through a pixel circuit a.

Referring to FIG. 2, it is assumed that the first gate circuit 41 is disposed at a left side of the pixel scan lines (G₁˜Gₙ), and a transmission direction of the output scan signal is a D1 direction; and the second gate circuit 42 is disposed at a right side of the pixel scan lines (G₁˜Gₙ), and a transmission direction of the output scan signal is a D2 direction.

When obtaining the scan signal V_{g}, the control unit 40 determines which gate circuit is to be used to output the scan signal. For example, the control unit 40 determines that the first gate circuit 41 should be used to output the scan signal V_{g} to each of the pixel scan lines (G₁˜Gₙ) during this frame scan operation. The control unit 40 uses the first gate circuit 41 to output the scan signal V_{g}, and the scan signal V_{g} is transmitted to each of the pixel circuits 2 in the D1 direction.

Similarly, the control unit 40 determines that the second gate circuit 42 should be used to output the scan signal V_{g} to each of the pixel scan lines (G₁˜Gₙ) during a next frame scan operation. The control unit 40 uses the second gate circuit 42 to output the scan signal V_{g}, and the scan signal V_{g} is transmitted to each of the pixel scan lines (G₁˜Gₙ) in the D2 direction. Therefore, in two continuous frame scan operations, the scan signal V_{g} is transmitted to the pixel scan lines in reverse directions.

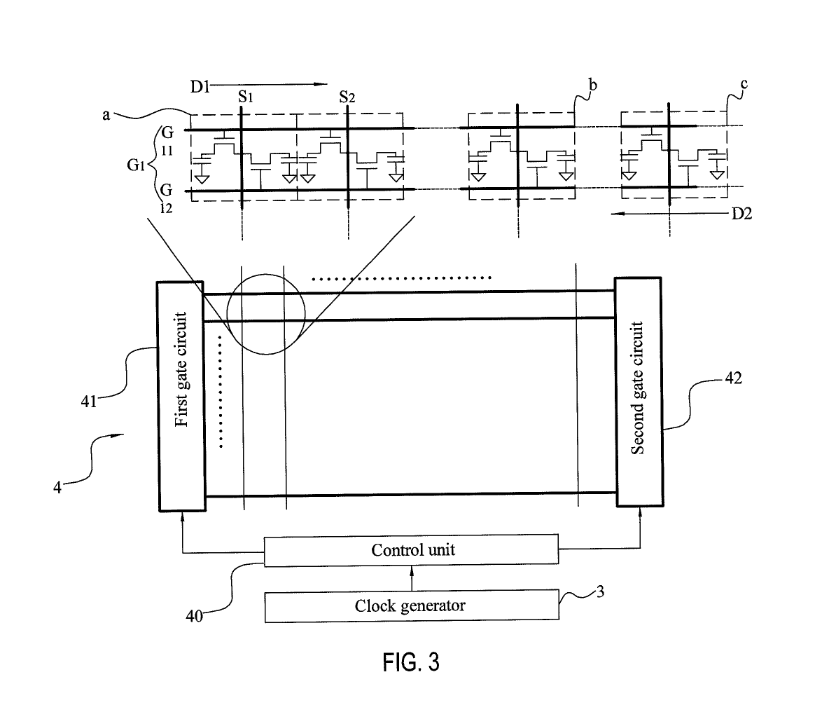

Referring to FIG. 3, an embodiment of the system architecture of FIG. 2 is shown, and in this embodiment, the specification of the gate circuit is, for example, a dual gate drive circuit, and each pixel scan circuit is connected with two input lines.

As shown in FIG. 3, by taking a pixel scan circuit G₁ as an example for illustration, the pixel scan circuit G₁ includes two input lines (G₁₁ and G₁₂), in which the input line G₁₁ is connected to the first gate circuit 41, and the input line G₁₂ is connected to the second gate circuit 42. When the control unit 40 uses the first gate circuit 41 to output the scan signal V_{g} to the pixel scan circuit G₁, the scan signal V_{g} is introduced from the input line G₁₁, so as to be transmitted from the pixel circuit a to a pixel circuit c, that is, in the D1 direction. On the contrary, when the control unit 40 uses the second gate circuit 42 to output the scan signal V_{g} to the pixel scan circuit G₁, the scan signal V_{g} is introduced from the input line G₁₂, so as to be transmitted from the pixel circuit c to the pixel circuit a, that is, in the D2 direction.

The gate circuit in this embodiment is not limited to the dual gate drive circuit shown in FIG. 3, and other types of dual gate drive circuits may also be used, as long as the transmission method of the scan signal on the pixel scan circuits can be changed.

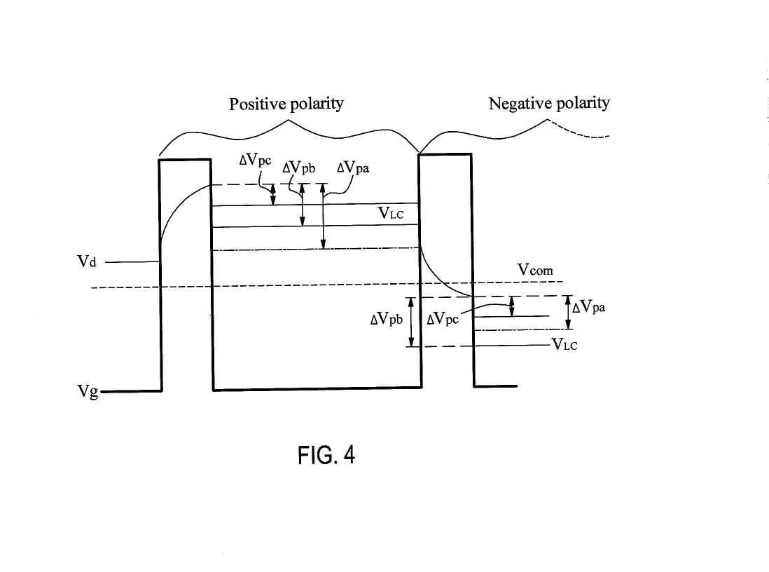

FIG. 4 is a schematic view of signal analysis about electric coupling among a pixel circuit a, a pixel circuit b, and a pixel circuit c in a scan signal transmission system according to an embodiment of the present invention. Referring to FIG. 4 together with FIG. 3, it is assumed that the pixel circuit a, the pixel circuit b, and the pixel circuit c are positive-polarity structures, and the scan signal V_{g} is transmitted from the pixel circuit a to the pixel circuit c in the D1 direction. As described in the prior art, when the scan signal V_{g} is transmitted from the pixel circuit a to the pixel circuit c, the scan signal V_{g} is deformed under the affect of the resistances of the pixel circuits 2, and due to the electric coupling effect between the scan signal V_{g} and each pixel circuit 2, a value of the pixel voltage difference ΔVₚ of the pixel circuit 2 is further reduced. As shown in FIG. 4, when the pixel circuit a, the pixel circuit b, and the pixel circuit c all have a positive polarity, the scan signal V_{g} has no distortion in the pixel circuit a, but the coupling effect is much severer than that in the pixel circuit b and the pixel circuit c; and the scan signal V_{g} has a severe distortion in the pixel circuit c and thus has a small coupling effect. Therefore, the pixel voltage difference ΔVₚₐ is greater than the pixel voltage difference ΔV_{pb}, and the pixel voltage difference ΔV_{pb} is greater than the pixel voltage difference ΔV_{pc}.

On the contrary, when the pixel circuit a, the pixel circuit b, and the pixel circuit c are negative-polarity structures, the scan signal V_{g} is transmitted from the pixel circuit c to the pixel circuit a in the D2 direction, the pixel voltage difference ΔV_{pc} is greater than the pixel voltage difference ΔV_{pb}, and the pixel voltage difference ΔV_{pb} is greater than the pixel voltage difference ΔVₚₐ.

However, as seen from FIG. 4, when the pixel circuit a is a positive-polarity structure, the pixel voltage difference of the pixel circuit a, that is, ΔVₚ=ΔVₚₐ>ΔV_{pb}, and a liquid crystal voltage V_{LC} corresponding to the pixel circuit a approaches the common drain voltage axis value V_{com}. When a next frame scan operation is performed, the pixel circuit a turns to a negative-polarity structure, the pixel voltage difference of the pixel circuit a, that is, ΔVₚ=ΔVₚₐ<ΔV_{pb}, and the liquid crystal voltage V_{LC} corresponding to the pixel circuit a also approaches the common drain voltage axis value V_{com}. Therefore, the V_{com} voltage symmetry of the pixel circuit a is similar to or the same as the V_{com} voltage symmetry of the pixel circuit b. Similarly, when the pixel circuit c is a positive-polarity structure, the pixel voltage difference of the pixel circuit c, that is, ΔVₚ=ΔV_{pc}<V_{pb}, and a liquid crystal voltage V_{LC} corresponding to the pixel circuit c approaches the common drain voltage axis value V_{com}. When a next frame scan operation is performed, the pixel circuit c turns to a negative-polarity structure, the pixel voltage difference of the pixel circuit c, that is, ΔVₚ=ΔV_{pc}>ΔV_{pb}, and the liquid crystal voltage V_{LC} corresponding to the pixel circuit c also approaches the common drain voltage axis value V_{com}. Therefore, the V_{com} voltage symmetry of the pixel circuit c is the same as the V_{com} voltage symmetry of the pixel circuit b.

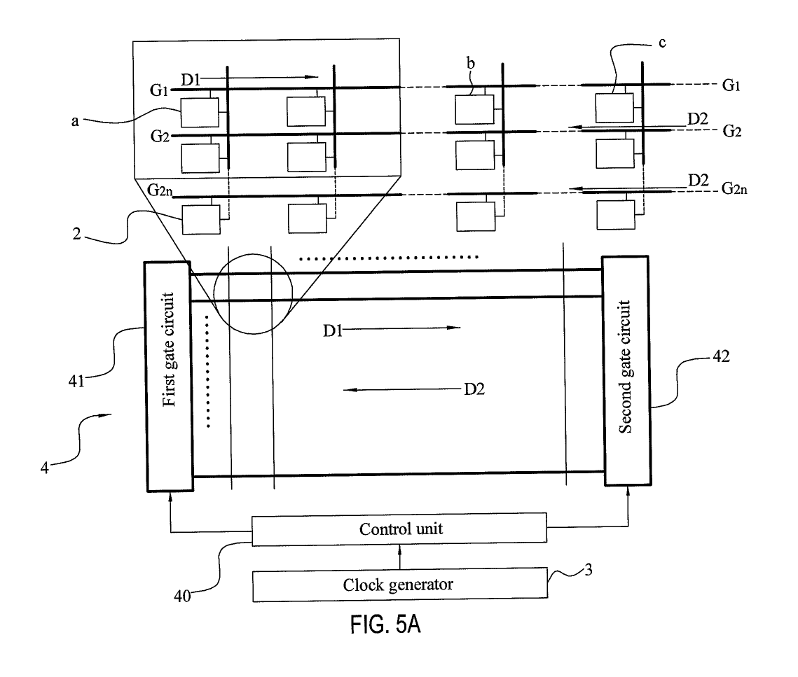

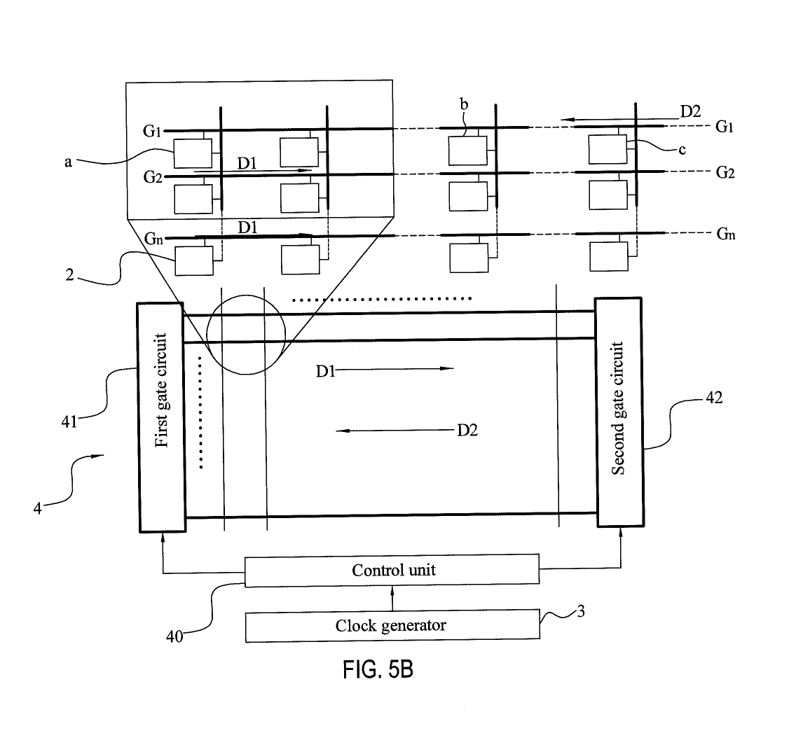

FIGS. 5A and 5B are schematic views of another system architecture of a scan signal transmission system according to an embodiment of the present invention. Referring to FIGS. 5A and 5B, in this embodiment, the first gate circuit 41 and the second gate circuit 42 are electrically connected to each of the pixel scan lines (G₁˜Gₙ), and the first gate circuit 41 and the second gate circuit 42 output the scan signal V_{g} in reverse directions. The control unit 40 respectively controls the first gate circuit 41 and the second gate circuit 42 to alternatively connect to and drive the pixel scan lines (G₁˜Gₙ) of different rows in different work cycles of the corresponding pixel scan lines (G₁˜Gₙ).

For example, in the current frame scan operation, the control unit 40 enables the first gate circuit 41 to be connected to the pixel scan lines of odd-number rows, such as G₁, G₃, G₅ . . . G₂ₙ₋₁, and enables the second gate circuit 42 to be connected to the pixel scan lines of even-number rows, such as G₂, G₄, G₆ . . . G₂ₙ. The scan signal V_{g} is transmitted to the pixel scan lines of odd-number rows in the D1 direction, and transmitted to the pixel scan lines of even-number rows in the D2 direction, as shown in FIG. 5A. On the contrary, in the next frame scan operation, the control unit 40 enables the second gate circuit 42 to be connected to the pixel scan lines of odd-number rows, such as G₁, G₃, G₅ . . . G₂ₙ₊₁, and enables the first gate circuit 41 to be connected to the pixel scan lines of even-number rows, such as G₂, G₄, G₆ . . . G₂ₙ. The scan signal V_{g} is transmitted to the pixel scan lines of odd-number rows in the D2 direction, and transmitted to the pixel scan lines of even-number rows in the D1 direction, as shown in FIG. 5B.

Similarly, in a further next frame scan operation, the control unit 40 enables the first gate circuit 41 to be connected to the pixel scan lines of odd-number rows, such as G₁, G₃, G₅ . . . G₂ₙ₋₁, and enables the second gate circuit 42 to be connected to the pixel scan lines of even-number rows, such as G₂, G₄, G₆ . . . G₂ₙ, as shown in FIG. 5A. The scan signal V_{g} is further transmitted to the pixel scan lines of odd-number rows in the D1 direction, and transmitted to the pixel scan lines of even-number rows in the D2 direction, and so forth. Therefore, the scan signal V_{g} is transmitted alternatively in reverse directions to each of the pixel scan lines (G₁˜Gₙ) sequentially, such that the liquid crystal voltage of each pixel circuit 2 approaches a specific V_{com}, so as to make the V_{com} voltage symmetry corresponding to each of the pixel circuits 2 become approximately the same, thus reducing the flickering effect of the display device.

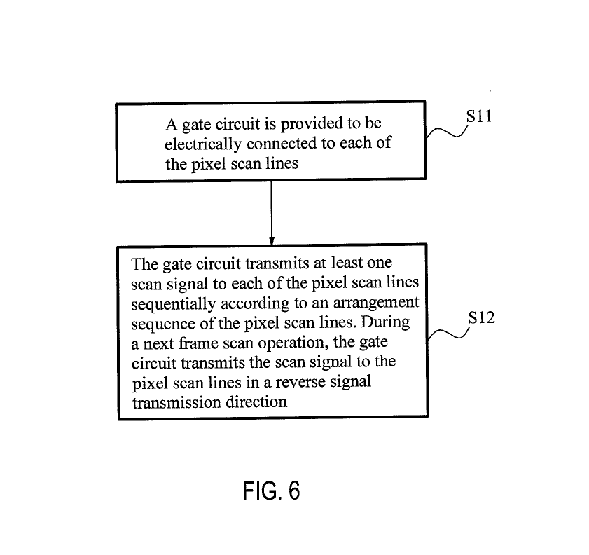

FIG. 6 is a schematic view of a scan signal transmission method according to an embodiment of the present invention. Please refer to FIGS. 2 to 5B for further understanding. As shown in FIG. 2, the method is applied to a display device, and the display device includes a plurality of pixel scan line (G₁˜Gₙ). The method includes the following steps.

A gate circuit is provided to be electrically connected to each of the pixel scan lines (Step S11). As shown in FIG. 2, the display device includes a display area circuit 43, the display area circuit 43 has a plurality of pixel circuits 2, a plurality of pixel scan lines (G₁˜Gₙ) is connected to the pixel circuits 2, each of the pixel scan lines (G₁˜Gₙ) is connected to the pixel circuits 2 in one row, and each of the pixel scan lines (G₁˜Gₙ) is connected to the gate circuit 4.

In this embodiment, the specification of the gate circuit 4 is, for example, a dual gate drive circuit, and the gate circuit 4 includes a control unit 40, a first gate circuit 41, and a second gate circuit 42. The first gate circuit 41 and the second gate circuit 42 are controlled by the control unit 40, and connected to two ends of each of the pixel scan lines (G₁˜Gₙ).

The gate circuit transmits at least one scan signal to each of the pixel scan lines sequentially according to an arrangement sequence of the pixel scan lines. During a next frame scan operation, the gate circuit transmits the scan signal to the pixel scan lines in a reverse signal transmission direction (Step S12).

As shown in FIG. 2, the gate circuit 4 obtains the scan signal periodically from the clock generator 3. The clock generator 3 is used for periodically generating at least one scan signal V_{g}, and transmitting the scan signal V_{g} to the gate circuit 4. According to the specification of the gate circuit 4, the scan signal V_{g} is received by the control unit 40, and is transmitted alternatively to the first gate circuit 41 or the second gate circuit 42 according to the actual requirements.

The control unit 40 controls the first gate circuit 41 and the second gate circuit 42 to transmit the scan signal V_{g} to each of the pixel scan lines (G₁˜Gₙ) sequentially according to the arrangement sequence of the pixel scan lines (G₁˜Gₙ). It is assumed that, the first gate circuit 41 is disposed at a left side of each of the pixel scan lines (G₁˜Gₙ), and a direction of the output scan signal V_{g} is the D1 direction; and the second gate circuit 42 is disposed at a right side of each of the pixel scan lines (G₁˜Gₙ), and a direction of the output scan signal V_{g} is the D2 direction. When the control unit 40 determines that the first gate circuit 41 should be used to output the scan signal V_{g} to each of the pixel scan lines (G₁˜Gₙ), the control unit 40 uses the first gate circuit 41 to output the scan signal V_{g}, and the scan signal V_{g} is transmitted to each of the pixel circuits 2 in the D1 direction.

In the next frame scan operation, the control unit 40 determines that the second gate circuit 42 should be used to output the scan signal V_{g} to each of the pixel scan lines (G₁˜Gₙ), the control unit 40 uses the second gate circuit 42 to output the scan signal V_{g}, and the scan signal V_{g} is transmitted to each of the pixel scan lines (G₁˜Gₙ) in the D2 direction, and so forth. Therefore, in two continuous frame scan operations, the scan signal V_{g} is transmitted to the same pixel scan line in reverse directions.

Referring to FIG. 3, an embodiment of the system architecture of FIG. 2 is shown. In this embodiment, each of the pixel scan lines (G₁˜Gₙ) includes two input lines (G₁₁ and G₁₂) to be individually connected to the first gate circuit 41 and the second gate circuit 42. When the control unit 40 uses the first gate circuit 41 to output the scan signal V_{g} to the pixel scan circuit G₁, the scan signal V_{g} is introduced from the input line G₁₁, so as to be transmitted from the pixel circuit a to the pixel circuit c, that is, in the D1 direction. On the contrary, when the control unit 40 uses the second gate circuit 42 to output the scan signal V_{g} to the pixel scan circuit G₁, the scan signal V_{g} is introduced from the input line G₁₂, so as to be transmitted from the pixel circuit c to the pixel circuit a, that is, in the D2 direction.

As shown in FIG. 4, when the pixel circuit a is a positive-polarity structure, the pixel voltage difference of the pixel circuit a, that is, ΔVₚ=ΔVₚₐ>ΔV_{pb}, and a liquid crystal voltage V_{LC} corresponding to the pixel circuit a approaches the common drain voltage axis value V_{com}. When a next frame scan operation is performed, the pixel circuit a turns to a negative-polarity structure, the pixel voltage difference of the pixel circuit a, that is, ΔVₚ=ΔVₚₐ<ΔV_{pb}, and the liquid crystal voltage V_{LC} corresponding to the pixel circuit a also approaches the common drain voltage axis value V_{com}. Therefore, the V_{com} voltage symmetry of the pixel circuit a is the same as the V_{com} voltage symmetry of the pixel circuit b.

Similarly, when the pixel circuit c is a positive-polarity structure, the pixel voltage difference of the pixel circuit c, that is, ΔVₚ=ΔV_{pc}<ΔV_{pb}, and a liquid crystal voltage V_{LC} corresponding to the pixel circuit c approaches the common drain voltage axis value V_{com}. When a next frame scan operation is performed, the pixel circuit c turns to a negative-polarity structure, the pixel voltage difference of the pixel circuit c, that is, ΔVₚ=ΔV_{pc}>ΔV_{pb}, and the liquid crystal voltage V_{LC} corresponding to the pixel circuit c also approaches the common drain voltage axis value V_{com}. Therefore, the V_{com} voltage symmetry of the pixel circuit c is the same as the V_{com} voltage symmetry of the pixel circuit b.

As shown in FIGS. 5A and 5B, the first gate circuit 41 and the second gate circuit 42 are electrically connected to each of the pixel scan lines (G₁˜Gₙ), and the first gate circuit 41 and the second gate circuit 42 output the scan signal V_{g} in reverse directions. The control unit 40 respectively controls the first gate circuit 41 and the second gate circuit 42 to alternatively connect to and drive the pixel scan lines (G₁˜Gₙ) of different rows in different work cycles of the corresponding pixel scan lines (G₁˜Gₙ).

For example, when the first gate circuit 41 is connected to the pixel scan lines of odd-number rows, the second gate circuit 42 is connected to the pixel scan lines of even-number rows. The scan signal V_{g} is transmitted to the pixel scan lines of odd-number rows in the D1 direction, and transmitted to the pixel scan lines of even-number rows in the D2 direction. In the next frame scan operation, when the second gate circuit 42 is connected to the pixel scan lines of odd-number rows, the first gate circuit 41 is connected to the pixel scan lines of even-number rows. The scan signal V_{g} is transmitted to the pixel scan lines of odd-number rows in the D2 direction, and transmitted to the pixel scan lines of even-number rows in the D1 direction, and so forth. Therefore, the scan signal V_{g} is transmitted alternatively in reverse directions to each of the pixel scan lines (G₁˜Gₙ) sequentially, such that the liquid crystal voltage of each of the pixel circuits (G₁˜Gₙ) approaches a specific V_{com}, so as to make the V_{com} voltage symmetry corresponding to each of the pixel circuits become approximately the same, thus reducing the flickering effect of the display device.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A scan signal transmission system, applied in a display device, the scan signal transmission system comprising:
a display area circuit, comprising a plurality of pixel scan lines; and
a gate circuit, electrically connected to the pixel scan lines, wherein the gate circuit transmits at least one scan signal to the pixel scan lines sequentially according to an arrangement sequence of the pixel scan lines, and transmits the scan signal to the pixel scan lines in a reverse signal transmission direction during a next frame scan operation.

2. The scan signal transmission system according to claim 1, further comprising a clock generator, for periodically generating the scan signal and transmitting the scan signal to the gate circuit.

3. The scan signal transmission system according to claim 1, wherein the gate circuit comprises a control unit, a first gate circuit, and a second gate circuit, the gate circuit is individually connected to two ends of the pixel scan lines, the control unit controls the first gate circuit and the second gate circuit to alternatively transmit the scan signal to the pixel scan lines in different work cycles of the pixel scan lines, and the first gate circuit and the second gate circuit transmit the scan signal in reverse directions.

4. The scan signal transmission system according to claim 3, wherein each of the pixel scan lines comprises two input lines to be respectively connected to the first gate circuit and the second gate circuit.

5. The scan signal transmission system according to claim 1, wherein a specification of the gate circuit is a dual gate drive circuit.

6. The scan signal transmission system according to claim 1, wherein the gate circuit comprises a control unit, a first gate circuit, and a second gate circuit, the gate circuit is individually disposed on two ends of the pixel scan lines, the first gate circuit and the second gate circuit transmit the scan signal in reverse directions, and the control unit respectively controls the first gate circuit and the second gate circuit to alternatively connect to and drive the pixel scan lines of different rows in different work cycles of the pixel scan lines.

7. The scan signal transmission system according to claim 6, wherein the first gate circuit drives the pixel scan lines of odd-number rows, the second gate circuit drives the pixel scan lines of even-number rows, and in a next work cycle of the pixel scan lines, the first gate circuit drives the pixel scan lines of even-number rows, and the second gate circuit drives the pixel scan lines of odd-number rows.

8. The scan signal transmission system according to claim 6, wherein the second gate circuit drives the pixel scan lines of odd-number rows, the first gate circuit drives the pixel scan lines of even-number rows, and in a next work cycle of the pixel scan lines, the second gate circuit drives the pixel scan lines of even-number rows, and the first gate circuit drives the pixel scan lines of odd-number rows.

9. A scan signal transmission method, applied in a display device comprising a plurality of pixel scan lines, the method comprising:
providing a gate circuit to be electrically connected to the pixel scan lines; and
the gate circuit transmitting at least one scan signal to the pixel scan lines sequentially according to an arrangement sequence of the pixel scan lines, wherein during each frame scan operation, the gate circuit transmits the scan signal to the pixel scan lines in a reverse signal transmission direction.

10. The scan signal transmission method according to claim 9, wherein the gate circuit obtains the scan signal periodically from a clock generator.

11. The scan signal transmission method according to claim 9, wherein the gate circuit comprises a control unit, a first gate circuit, and a second gate circuit, the gate circuit is individually connected to two ends of the pixel scan lines, the control unit controls the first gate circuit and the second gate circuit to alternatively transmit the scan signal to the pixel scan lines in different work cycles of the pixel scan lines, and the first gate circuit and the second gate circuit transmit the scan signal in reverse directions.

12. The scan signal transmission method according to claim 11, wherein each of the pixel scan lines comprises two input lines to be individually connected to the first gate circuit and the second gate circuit.

13. The scan signal transmission method according to claim 9, wherein a specification of the gate circuit is a dual gate drive circuit.

14. The scan signal transmission method according to claim 9, wherein the gate circuit comprises a control unit, a first gate circuit, and a second gate circuit, the gate circuit is individually disposed on two ends of the pixel scan lines, the first gate circuit and the second gate circuit transmit the scan signal in reverse directions, and the control unit respectively controls the first gate circuit and the second gate circuit to alternatively connect to and drive the pixel scan lines of different rows in different work cycles of the pixel scan lines.

15. The scan signal transmission method according to claim 14, wherein the first gate circuit drives the pixel scan lines of odd-number rows, the second gate circuit drives the pixel scan lines of even-number rows, and in a next work cycle of the pixel scan lines, the first gate circuit drives the pixel scan lines of even-number rows, and the second gate circuit drives the pixel scan lines of odd-number rows.
